(19) United States
(12) Patent Application Publication
(10) Pub. No.: US 2003/0019077 A1
(43) Pub. Date: Jan. 30, 2003

(54) Fastening mechanism for doorknob

(76) Inventor: Zheng-Zhong Liao, Hsin Tien City (TW)

Correspondence Address: BACON & THOMAS, PLLC, 625 Slaters Lane, 4th Floor, Alexandria, VA, 22314-1176, US

(21) Appl. No.: 09/912,354

(22) Filed: Jul. 26, 2001

(51) Int. Cl. E05F 1/08

(52) U.S. Cl. 16/76

(57) ABSTRACT

A doorknob comprises a hollow plastic member having one end fixed to a wall, and the other end open to outside, the hollow member including a plurality of elongate gaps equally spaced on a surface each extended from the open end to a predetermined position thereon and a neck adjacent the open end, wherein the open end of the hollow member and the neck will expand laterally until the doorknob being inserted into the hollow member.

### FIELD OF THE INVENTION

The present invention relates to doorknobs and more particularly to a fastening mechanism for doorknob with improved characteristics.

### BACKGROUND OF THE INVENTION

A conventional fastening mechanism for doorknob comprises a connection member fixed to a wall, a link coupled to an outer end of connection member, a magnetic member mounted on link, and a metal member mounted on a side of door facing magnetic member. In one operation, after door is opened push door toward the wall to magnetically secure door to fastening mechanism by engaging metal member with magnetic member. In another operation, disengaging metal member from magnetic member prior to closing door. With this configuration, a potential collision of door and wall is eliminated, thus protecting the door.

But this is unsatisfactory for the purpose for which the invention is concerned for the following reasons: the magnetic force of magnetic member may become weak after a predetermined period time of use, resulting in a malfunction of the engagement of magnetic member and metal member. In response, user has to replace the worn link and magnetic member. Such replacement really bothers user. Further, in installing connection member and link they are required to be precisely mounted on predetermined positions. Otherwise, a desired releasable coupling of magnetic member and metal member is not obtained. However, such precise installation is often unobtainable. Thus improvement exists.

### SUMMARY OF THE INVENTION

It is therefore an object of the present invention to provide a reliable and durable fastening mechanism for a doorknob comprising an engagement member fixed to a wall; a connection member having one end coupled to the engagement member; and a hollow plastic member having one end coupled to the other end of the connection member and the other end open to outside, the hollow member including a plurality of elongate gaps equally spaced on a surface each extended from the open end to a predetermined position thereon and a neck adjacent the open end. The doorknob is operative to insert into the hollow member so as to cause the open end of the hollow member and the neck to expand laterally until a further insertion of the doorknob into the hollow member is stopped. The expanded hollow member is subsequently compressed for securing the doorknob to the hollow member.

The above and other objects, features and advantages of the present invention will become apparent from the following detailed description taken with the accompanying drawings.

### BRIEF DESCRIPTION OF THE DRAWINGS

FIG. 1 is a perspective view of a fastening mechanism for doorknob according to the invention; and

FIG. 2 is a side view in part section showing the relative positions of doorknob and fastening mechanism prior to engagement.

### DETAILED DESCRIPTION OF THE PREFERRED EMBODIMENTS

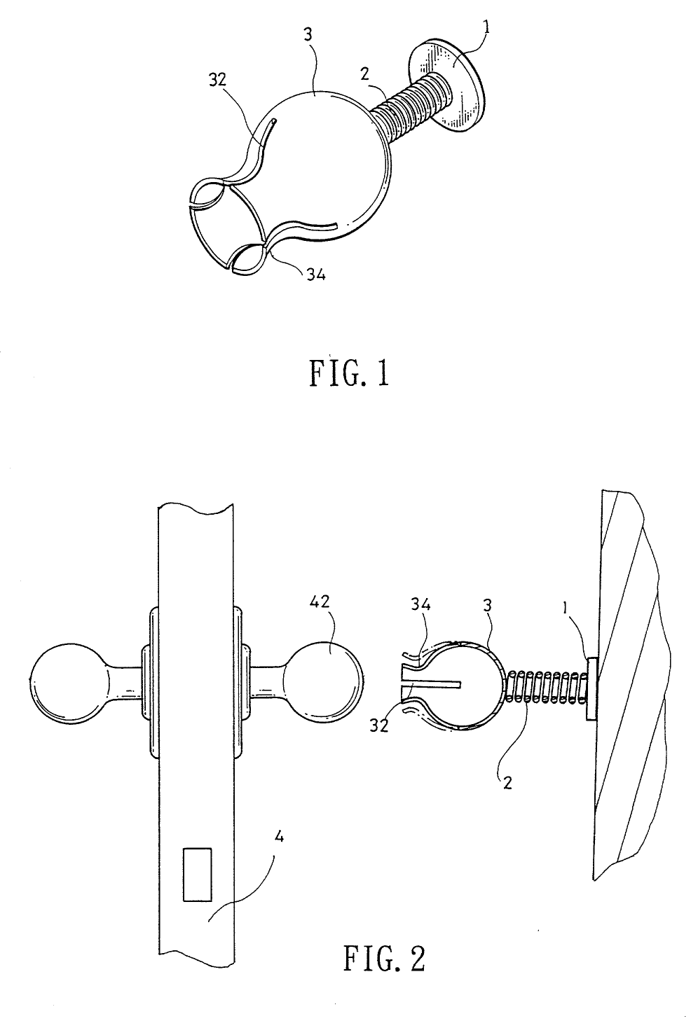

Referring to FIGS. 1 and 2, there is shown a fastening mechanism for doorknob 42 of a door 4 in accordance with the invention. The fastening mechanism comprises an engagement member 1 fixed to a wall, a connection member 2 (e.g., spring as shown but it may be replaced by another suitable device in other embodiments) having one end coupled to engagement member 1, a hollow plastic member 3 having one end coupled to the other end of connection member 2 and the other end open to outside and including a plurality of elongate gaps 32 equally spaced on the surface each extended from the open end to an about intermediate position thereon and a neck 34 adjacent the open end.

In one operation, after door 4 is opened push door 4 toward the wall. In inserting doorknob 42 into the hollow member 3, the open end of hollow member 3 and neck 34 will be forced to expand laterally until the front end of doorknob 42 contacts inner rear end of hollow member 3. At this position, once expanded hollow member 3 is again compressed so as to secure doorknob 42 (i.e., door 4) to the hollow member 3 (i.e., fastening mechanism). In another operation, disengaging door 4 from the hollow member 3 by pulling the other doorknob 42 prior to closing door 4.

By utilizing this, the engagement or disengagement of doorknob 42 and fastening mechanism is much easy. Further, the invention is reliable and durable. Moreover, drawbacks associated with prior art fastening mechanism for doorknob such as weak magnetic force of magnetic member as time passes and a precise installation of connection member and link are substantially eliminated.

While the invention has been described by means of specific embodiments, numerous modifications and variations could be made thereto by those skilled in the art without departing from the scope and spirit of the invention set forth in the claims.

What is claimed is:

1. A fastening mechanism for a doorknob comprising:
an engagement member having one end fixed to a wall; and
a hollow plastic member having one end coupled to the other end of said engagement member and the other end open to outside, said hollow member including a plurality of elongate gaps equally spaced on a surface each extended from the open end to a predetermined position thereon and a neck adjacent the open end;
wherein said doorknob is operative to insert into said hollow member so as to cause the open end of said hollow member and said neck to expand laterally until a further insertion of said doorknob into said hollow member is stopped; and said expanded hollow member is subsequently compressed for securing said doorknob to said hollow member.

2. The fastening mechanism of claim 1, wherein said fastening mechanism further comprises a connection member having one end coupled to said engagement member, and the other end coupled to said hollow plastic member.

3. The fastening mechanism of claim 2, wherein said connection member is a spring.
